(19) United States
(12) Patent Application Publication
(10) Pub. No.: US 2018/0081666 A1
(43) Pub. Date: Mar. 22, 2018

(54) Reliable and Secure Firmware Update for Internet of Things (IoT) Devices

(71) Applicant: Oleksii Surdu, Broadlands, VA (US)

(72) Inventor: Oleksii Surdu, Broadlands, VA (US)

(21) Appl. No.: 15/067,405

(22) Filed: Mar. 11, 2016

(51) Int. Cl. G06F 9/445; G06F 21/57

(52) U.S. Cl. CPC G06F 8/65; G06F 11/1469; G06F 21/572

(57) ABSTRACT

A method and system for a secure and reliable firmware update and management of Internet of Things (IoT) devices. The invention uses a Trusted Execution Environment (TEE) for hardware-based isolation of the critical modules and staging environment during the firmware update process and regular work. The isolation is performed by hardware System on a Chip (SoC) Security Extensions such as ARM TrustZone or similar technologies on other hardware platforms.

The invention therefore comprises Software Configuration Management (SCM) and firmware update code running in the TEE with dedicated memory and storage, thus providing a trusted configuration management functionality for the OS system code and applications on IoT devices. Embodiments of the invention create a new (staging) isolated execution environment, copy the current system into the new environment, and perform the firmware update process. All changes are applied to the staging environment only, and therefore do not stop or interrupt execution of the current OS on the IoT device. The staging environment uses device drivers in the emulation mode without access to the real hardware.

### BACKGROUND OF THE INVENTION

With the growing number of deployed IoT devices the importance of secure firmware updating is significantly increased. Gartner, Inc. forecasts that 6.4 billion connected things will be in use worldwide in 2016, up 30 percent from 2015, and will reach 20.8 billion by 2020. In 2016, 5.5 million new things will get connected every day.

All these devices need a reliable firmware update system. The functions of many IoT devices, expected to be operational typically at all times, requires a minimal downtime for service tasks, including firmware update. The present invention provides a solution using parallel updates when all service actions are applied to the clone of the current execution environment with the extensive tests at the end. As soon as the new execution environment is ready and verified, a fast switch between execution environments occurs with the optional configuration synchronization.

A typical IoT device is also expected to be operational for a long time and may warrant or require many updates over its life. A consumer of an IoT solution needs to be able to receive and perform firmware updates for IoT devices to fix security vulnerabilities and firmware errors or add new features. The firmware update should be simple and should provide an easy way to roll back to the previous version if for any reason the update is ineffective. The embodiments of the present invention address these requirements and also allow to return back to the previous version of the firmware at any time.

In November 2015, ARM announced launch of the ARMv8-M architecture with ARM TrustZone technology. It provides developers with a reasonably fast and efficient way of protecting embedded software running on Internet of Things (IoT) devices. The present invention fully utilizes capabilities of the Security Extensions in an innovative way to implement a reliable and secure firmware update for Internet of Things (IoT) devices.

Limitations of the traditional firmware update approaches, compared to the present invention, will become apparent to the person having ordinary skill in the art through comparison of such approaches with the present invention.

### RELATED ART

The following references identify related art:

[1] Young, Fudally, Montgomery, “Secure Firmware Updates”, U.S. Pat. No. 9,218,178 B2, Dec. 22, 2015. [1] describes a secure firmware update system based on a pre-boot environment. The present invention uses Security Extensions of the hardware platform to provide TEE for firmware update process and is better suited for IoT devices.

[2]I Insyde Software Corp, “System And Method For Updating Firmware”, U.S. Pat. No. 9,235,403 B2, Jan. 12, 2016. [2] describes a firmware update mechanism which uses ROM image to store firmware update code. While this approach provides a reliable protection for the updater code it prevents future updates of the updater itself. The present invention does not have this limitation.

[3]I Keller, Sotack, Hayter, “Failsafe Firmware Updates”, U.S. Patent Application US 2012/0260244 A1, Oct. 11, 2012. [3] describes a failsafe method of updating an electronic device using 3 separate non-volatile memory partitions. The present invention supports multiple dynamic copies of the execution environment and ability to switch between copies at any time with optional configuration synchronization.

[4] Challener, Davis, Springfield, Waltermann, Lenovo Singapore Pte Ltd, “System And Method To Update Device Driver Or Firmware Using A Hypervisor Environment Without System Shutdown”, U.S. Pat. No. 8,201,161 B2, Jun. 12, 2012. [4] describes a system, method, and program for a firmware/driver update of a device using a hypervisor environment without system shutdown. The present invention uses firmware update code running in the TEE to update the whole IoT device OS and not only device drivers or firmware.

[5] Cassapakis Chris , Rao Bindu Rama, Palm Inc, “Updating An Electronic Device With Update Agent Code”, U.S. Pat. No. 8,578,361 B2, Nov. 5, 2013. [5] describes a method of updating an electronic device with update agent code. The present invention runs firmware update code in TEE and applies all changes to the cloned OS without modification of the original execution environment. This process do not interrupt the work of IoT device and requires only a minimal downtime during execution environment switch.

### BRIEF DESCRIPTION OF THE DRAWINGS

FIG. 1 illustrates an IoT Device Firmware structure, All critical code and data are protected by the Trusted Execution Environment and cannot be altered or damaged by OS code. By default an OS uses real peripheral devices connected to the IoT device. To avoid hardware conflicts during the firmware update process, a new execution environment uses device drivers in the emulation mode.

FIG. 2 illustrates the firmware update process of an IoT device using the present invention. The process has several steps including preparation of a new execution environment, cloning of the current environment, applying a verified update package and performing post-update validation tests.

FIG. 3 illustrates the process of switching into the new execution environment. It occurs only after successful completion of the update process. Optionally the embodiments of the invention can save the state of the previous execution environment and restore it inside a new environment before its activation.

During the switching process a new execution environment receives an access to the real hardware (peripheral) devices connected to an IoT device and becomes a primary environment.

FIG. 4 describes the recovery process. A backup copy of the previous versions of the execution environment created during the update/switching process can be used for recovery initiated either by a user or automatically in case of detected failures in the new primary execution environment. Optionally an IoT device firmware can be restored into the factory default state using traditional methods either by using a reserved recovery partition or a firmware image on external removable storage.

### DETAILED DESCRIPTION

Preferred embodiments of the present invention should have a hardware-enforced Trusted Execution. Environment (TEE). While the main purpose of SoC Security Extensions is isolation between “Normal” and “Secure Worlds”, as those terms are defined in ARM TrustZone use, the present invention provides the innovative approach of using these Security Extensions to isolate and protect firmware update system for an IoT device.

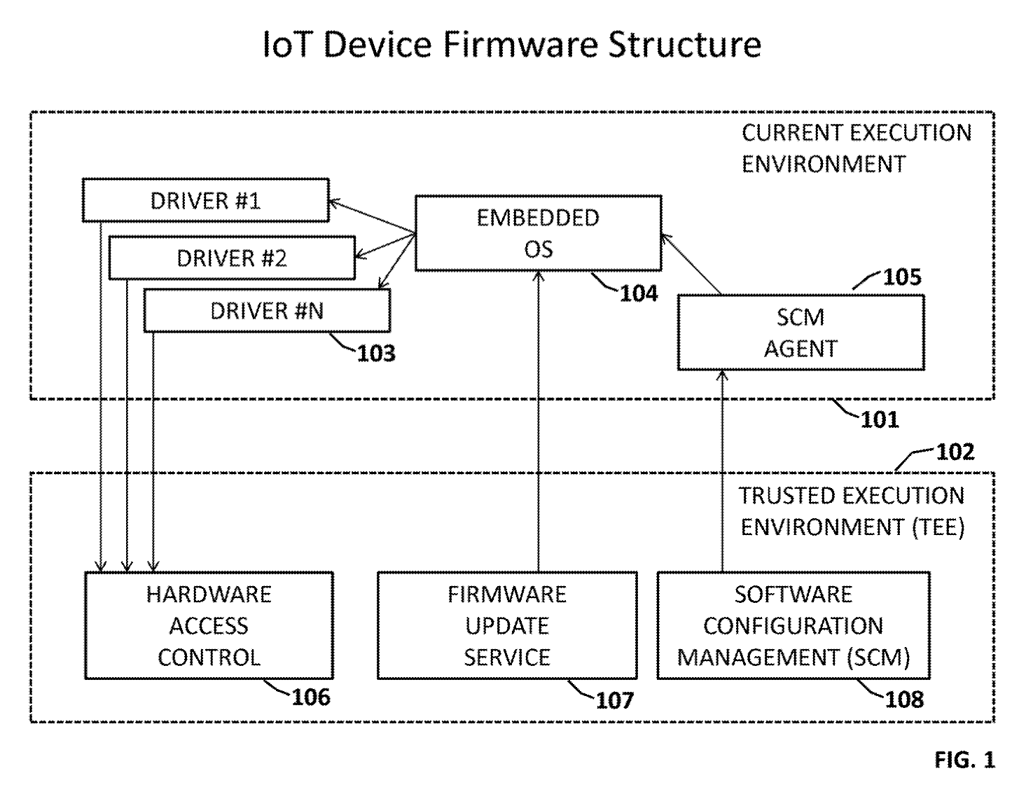

FIG. 1 illustrates an IoT Device Firmware structure. Embedded OS (104) with the SCM Agent (105) are running in the Current Execution Environment (101). In the default execution mode the Embedded OS uses Drivers (103) connected to the real hardware. Hardware Access Control (106) controls access to the peripheral devices connected to the IoT device. Other execution environments uses device drivers in the emulation mode to avoid collisions and does not have an access to the real hardware.

All critical firmware update modules Hardware Access Control (HAC), Firmware Update Service (FUS) (107), and Software Configuration Management (SCM) (108)—are running in the Trusted Execution Environment (102). Internal data (including cryptographic keys, certificates, configurations) of these modules is protected by the hardware Security Extensions too.

FUS provides a functionality to verify Firmware Update Package (FUP) using cryptographic algorithms inside TEE, creates a new (Stage) execution environment, copies existing execution environment into the new one, and applies an update. After successful update the control is passed to the SCM. The SCM is responsible for post update validation testing, configuration backup and restore, and execution environment activation and deactivation.

The SCM performs health monitoring of the Embedded OS Execution Environment. In case of detected problems SCM may initiate rollback to one of the previous copies of the execution environment or to the factory default state if no backup copies exist.

Optionally, the SCM may backup configuration and current state of the execution environment at defined intervals and store it in a separate protected database. A user may use this data later to create a new execution environment or restore a previous version of the environment.

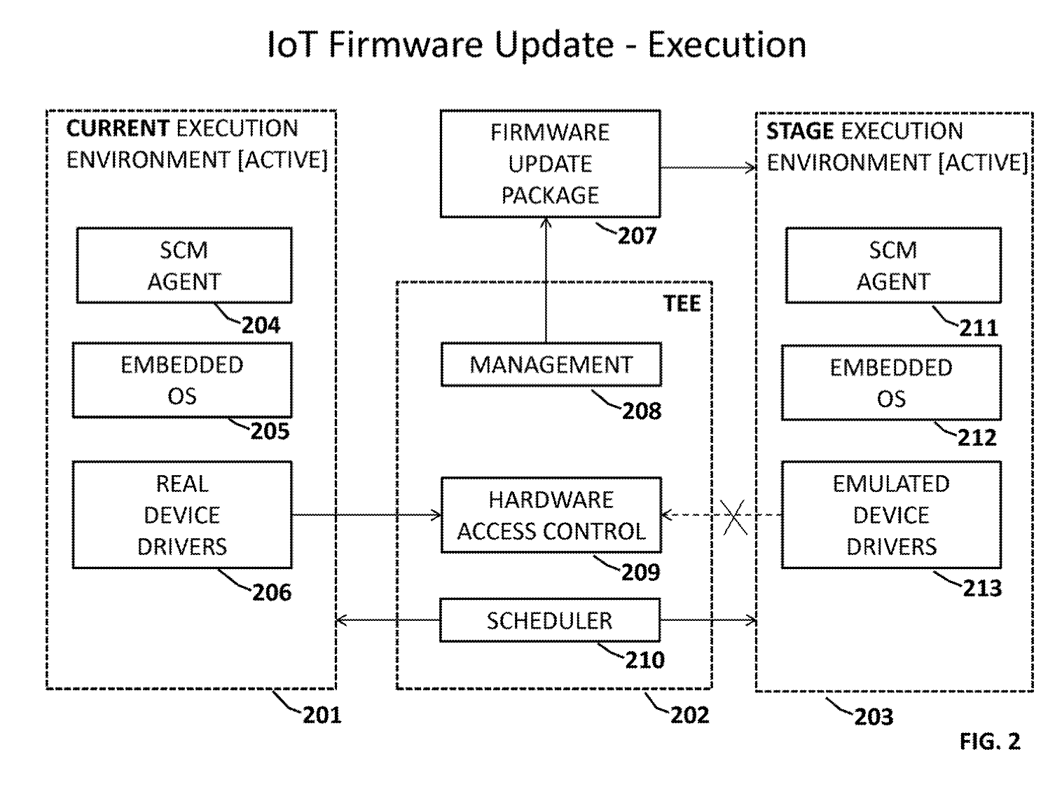

FIG. 2 illustrates the firmware update process of an IoT device. During this process Management (208) creates a new isolated Stage Execution Environment (SEE) (203) for the Embedded OS (212) and applications (211), copies the Current Execution Environment (CEE) (201) into the SEE and applies the FUP (207). This process does not stop or interrupt execution of the current embedded OS (205) or applications (204) and drivers (206). After successful update the new SEE is verified externally (by the SCM running in the TEE (202)) and internally (using SCM Agent).

The Scheduler (210) is responsible for parallel execution of multiple execution environments. During the update process of the SEE, the CEE supports normal operation and works in parallel. The SEE can receive significantly lower execution priority compared to the CEE because boot time of the Stage environment is not really important.

Hardware Access Control (209) manages access to the peripheral devices connected to the IoT device. SEE uses device drivers in the emulation mode (213) to avoid collisions.

Optionally an external agent such as the user or service may clone the existing execution environment and activate it without an actual firmware update. This action can be used to create an on-the-fly backup of the IoT device firmware.

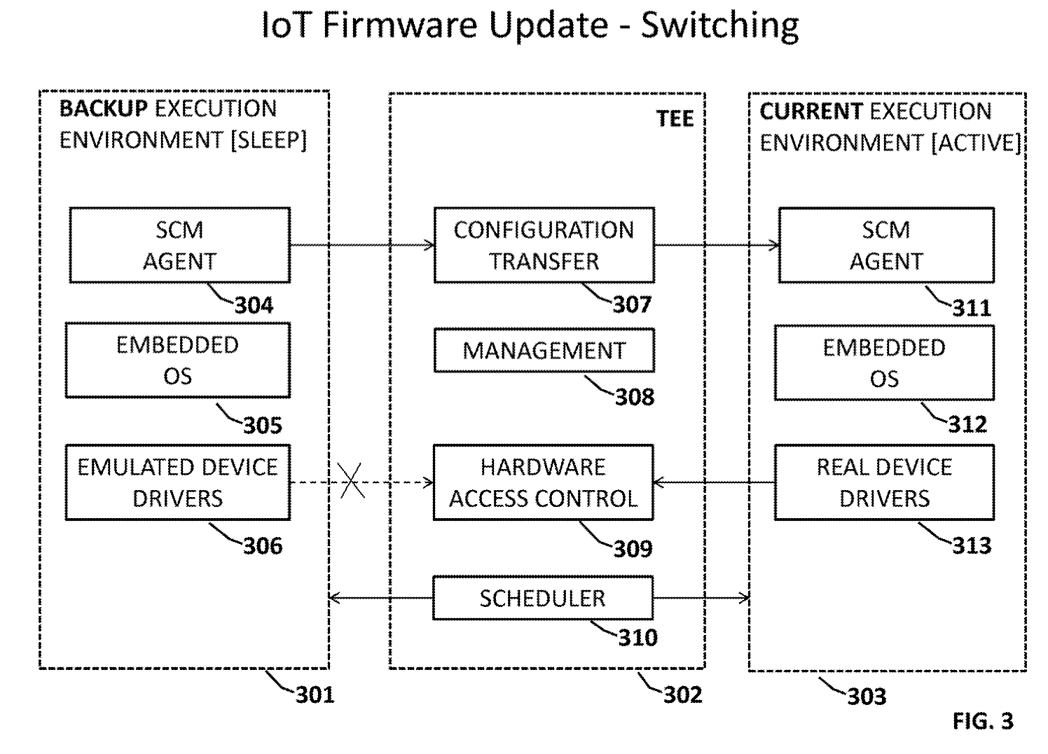

FIG. 3 illustrates the process of switching into the new execution environment (303) initiated by Management (308). Original CEE becomes Backup Execution Environment (BEE) (301) and SEE becomes CEE. Optionally, the embodiments of the invention can save the state of the previous execution environment using SCM Agent (304) and restore it inside a new environment using SCM Agent (311) before its activation. Configuration Transfer (307) module running in the TEE (302) is responsible for this task. No direct connection between SCM Agents of two execution environments is allowed.

During the switching process, new execution environment OS (312) receives an access to the hardware via Real Device Drivers (313) and Hardware Access Control (309) while Backup Execution Environment (301) OS (305) switches to Emulated Device Drivers (306). Later this execution environment can be used for recovery initiated either by a user or automatically in case of detected failures in the new primary execution environment.

After successful update, validation of the new environment and switching between environments, the BEE remains active for the defined interval and works in parallel. The BEE is hibernated or shut down by the Scheduler (310) after receiving a confirmation from the new CEE about successful competition of the switching process.

Optionally, a user or external service can initiate switching between CEE and BEE without an actual firmware update or recovery.

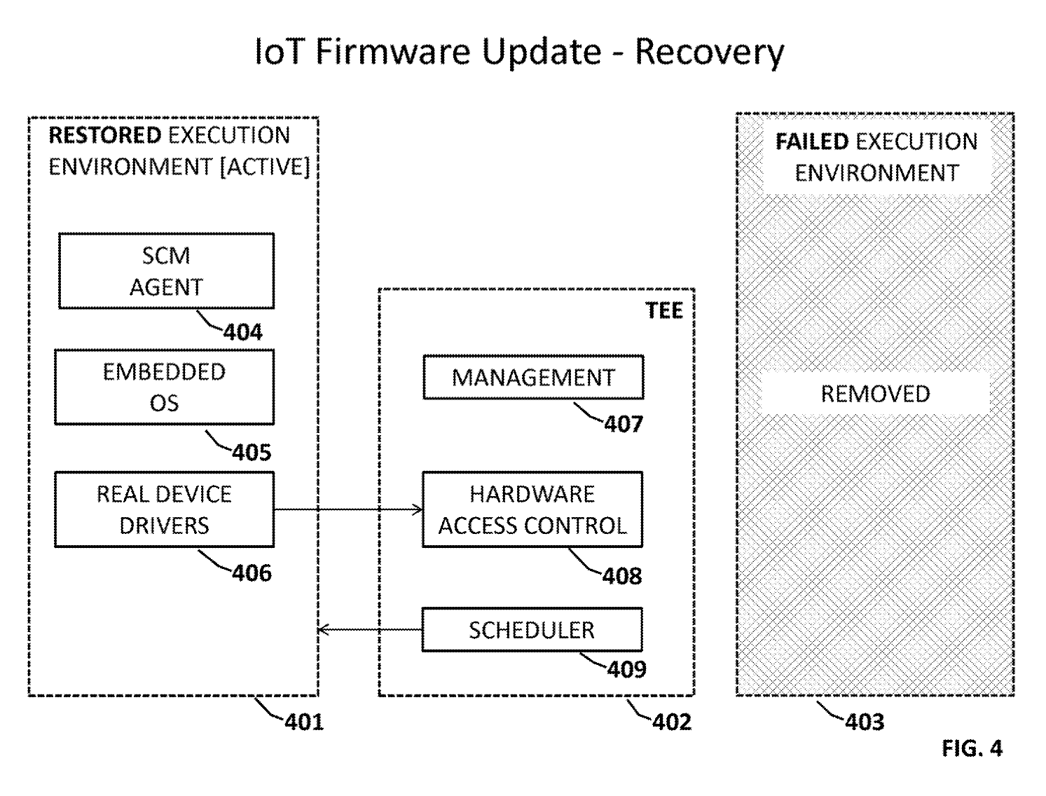

FIG. 4 describes the recovery process. OS (405), as the backup copy of the previous versions of the execution environment (401), receives an access to the real device drivers (406) and configuration provided by the SCM Agent (404). Management (407) running in TEE (402) activates the backup execution environment and sets new rules for Hardware Access Control (408). The Failed Execution Environment (403) is then removed. Scheduler (409) controls execution environments and performs environment activation and deactivation.

The recovery process can be initiated either by a user or by the Management module in case of detected failures in the execution environment. Optionally, the configuration and state of the execution environment can be restored from separate backup copies created by the SCM during normal operations.

We claim:

1. A computing system with secure and reliable firmware update and management comprising:
a. a computing system based on an System on a Chip (SoC) with integrated Security Extensions or similar technology capable of a creating Trusted Execution Environment (TEE);
b. a firmware update system running in TEE with dedicated memory and storage;
c. multiple Operating Systems (OS's) which are running in separated execution environments with dedicated memory and storage;
d. wherein the TEE is hardware isolated from other execution environments using the computing system's hardware capabilities;
e. wherein access to the internal data and code execution of the firmware update system are allowed from the TEE only;
f. wherein the firmware update system performs integrity and authenticity validation and management of the computer system firmware update packages;
g. wherein the computer system is operating under current OS control creating a Current Execution Environment (CEE)
h. wherein the firmware update system initializes and runs a separate execution environment with new firmware within it, thereby creating a Stage Execution Environment (SEE);
i. wherein the SEE is running in parallel with the CEE;
j. wherein the CEE works with the normal device drivers while the SEE uses device drivers in the emulation mode to avoid collisions during SEE boot and initialization;
k. wherein the SEE is synchronizing configuration with the CEE;
l. wherein the firmware update system, upon successful boot and initialization of the SEE, switches CEE and SEE roles, such that the SEE starts to work with the normal device drivers while the CEE uses device drivers in the emulation mode to avoid collisions, and thereby the SEE becomes a CEE;
m. wherein the firmware update system returns to its previous CEE state in the even any problem with the new CEE is experienced.

2. The computing system as claimed in claim 1 wherein access to the connected peripheral hardware devices is controlled by a Hardware Access Control module running in the TEE and isolating the SEE from the real hardware, thereby preventing possible damage to the computing system operation in the event of unworkable firmware running in the SEE;

3. The computing system as claimed in claim 1 wherein the computing system is an IoT device, mobile device, workstation or server.

4. The computing system as claimed in claim 1 wherein the TEE environment is running on a separate hardware physically integrated into a computing system.

5. The computing system as claimed in claim 1 wherein the TEE environment is running other types of systems and services in parallel with the described firmware update system, such as DRM, cryptographic services, trusted apps, etc.

6. The computing system as claimed in claim 1 wherein multiple copies of SEE's can be created with different firmware versions and configurations.

7. The computing system as claimed in claim 6 wherein a user or an external service can switch to any of the available SEE's with optional configuration synchronization.
